(19) United States
(12) Patent Application Publication
(10) Pub. No.: US 2024/0311740 A1
(43) Pub. Date: Sep. 19, 2024

(54) GRAPH DATABASE REPORTING

(71) Applicant: RAKUTEN MOBILE, INC, Tokyo (JP)

(72) Inventors: Pawan SHRIWAS, Indore (IN); Krishna PATEL, Indore (IN)

(73) Assignee: RAKUTEN MOBILE, INC, Tokyo (JP)

(21) Appl. No.: 18/027,011

(22) PCT Filed: Dec. 28, 2022
(86) PCT No.: PCT/US2022/054114

§ 371 Date: Mar. 17, 2023

(30) Foreign Application Priority Data
Nov. 11, 2022 (IN) 202241064636

(51) Int. Cl. G06Q 10/067; G06F 16/901

(52) U.S. Cl. CPC G06Q 10/067; G06F 16/9024

(57) ABSTRACT

Embodiments herein provide a report management system for generating business intelligence (BI) report. The report management system includes a reporting service controller configured to create a BI report request to download a BI report using a BI template from a plurality of BI templates. The BI report request includes a list of data filters and a specific report format required by a user. Further, the reporting service controller is configured to create a connection with a graph database using a certified API. Using the certified API, the reporting service controller is configured to retrieve the BI data from the graph database based on the list of filters indicated in the BI report request. Based on the specific report format required by the user, the reporting service controller is configured to generate the BI report includes the retrieved BI data from the graph database.

### FIELD OF INVENTION

The present disclosure relates to a business intelligence (BI) report management method, and more particularly to a method and a report management system for generating business intelligence (BI) report.

### BACKGROUND

In general, a business intelligence (BI) report service works on a database (e.g., Relational Database Management System (RDBMS) style database, SQL database or the like) but inventory data (e.g., multiple domain information, multiple technology information or the like) reside on a graph database which is not supported in a BI system. Current, the BI system is not capable of perform reporting with a graph database solution. Further, the multiple domain information and multiple technology information are stored in different tables in the RDBMS database or SQL database and difficult to provide a relationship between the multiple domain information and multiple technology information in the RDBMS database or the SQL database. The providing relationship between the multiple domain information and multiple technology information in the RDBMS database or the SQL database are time consuming.

Thus, it is desired to address the above-mentioned disadvantages or other shortcomings or at least provide a useful alternative.

### OBJECT OF INVENTION

The principal object of the embodiments herein is to provide a method and a report management system for generating business intelligence (BI) report. The proposed method can be used to assist in providing reporting solution for a graph database with help of a processor (e.g., generic report processor) in a BI tool. The proposed method can be used to integrate a generic process with the BI tool to fetch a data from the graph database and create a report which will be serve by a display (e.g., BI screen or the like). The method can be used in assisting in generation of report for the graph database. In the proposed method, only report query is need to be configured and the method and the report management system does not require an additional development or modification. The method and the report management system can be scalable for large number of report as well.

### SUMMARY

Accordingly, the embodiment herein discloses a report management system for generating business intelligence (BI) report. The report management system includes a display, a processor, and a storage. The storage is coupled to the processor, where the storage stores a plurality of BI templates. A reporting service controller is coupled to the processor and the display. The reporting service controller is configured to create a BI report request to download the BI report using a BI template from a plurality of BI templates. The BI report request includes a list of data filters and a specific report format required by a user. Further, the reporting service controller is configured to create a connection with a graph database using a certified API. The graph database includes graphs containing nodes, edges, and properties, all of which are used to represent and store the BI data. Using the certified API, the reporting service controller is configured to retrieve the BI data from the graph database based on the list of filters indicated in the BI report request. Based on the specific report format required by the user, the reporting service controller is configured to generate the BI report includes the retrieved BI data from the graph database. Further, the reporting service controller is configured to store the BI report in the storage and display the BI report on the display to the user.

Accordingly, the embodiment herein discloses a method for generating business intelligence (BI) report. The method includes storing, by the report management system, a plurality of BI templates. Further, the method includes creating, by the report management system, a BI report request to download the BI report using a BI template from the plurality of BI templates. The BI report request includes a list of data filters and a specific report format required by a user. Further, the method includes creating, by the report management system, a connection with a graph database using a certified API. The graph database includes graphs containing nodes, edges, and properties, all of which are used to represent and store the BI data. Further, the method includes retrieving, by the report management system, the BI data from the graph database using the certified API based on the list of filters indicated in the BI report request. Further, the method includes generating, by the report management system, the BI report comprising the retrieved BI data from the graph database based on the specific report format required by the user. Further, the method includes storing, by the report management system, the BI report. Further, the method includes displaying, by the report management system, the BI report on the display to the user.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### BRIEF DESCRIPTION OF FIGURES

The method and the electronic device are illustrated in the accompanying drawings, throughout which like reference letters indicate corresponding parts in the various figures. The embodiments herein will be better understood from the following description with reference to the drawings, in which:

FIG. 1 is an example overview of a report management system for generating a business intelligence (BI) report, according to the embodiments as disclosed herein;

FIG. 2 shows various hardware components of a reporting service controller of the report management system, according to the embodiments as disclosed herein;

FIG. 3A and FIG. 3B are flow charts illustrating a method for generating the BI report, according to the embodiments as disclosed herein;

FIG. 4 is an example flow chart illustrating a method for generating the BI report, according to the embodiments as disclosed herein;

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Accordingly, the embodiment herein is to provide a report management system for generating a BI report. The report management system includes a display, a processor, and a storage. The storage is coupled to the processor, where the storage stores a plurality of BI templates. A reporting service controller is coupled to the processor and the display. The reporting service controller is configured to create a BI report request to download the BI report using a BI template from the plurality of BI templates. The BI report request includes a list of data filters and a specific report format required by a user. Further, the reporting service controller is configured to create a connection with a graph database using a certified API. The graph database includes graphs containing nodes, edges, and properties, all of which are used to represent and store the BI data. Using the certified API, the reporting service controller is configured to retrieve the BI data from the graph database based on the list of filters indicated in the BI report request. Based on the specific report format required by the user, the reporting service controller is configured to generate the BI report includes the retrieved BI data from the graph database. Further, the reporting service controller is configured to store the BI report in the storage and display the BI report on the display to the user.

Unlike conventional methods and systems, the proposed method can be used to assist in providing reporting solution for a graph database with help of a processor (e.g., generic report processor) in a BI tool. The proposed method can be used to integrate a generic process with the BI tool to fetch a data from the graph database and create a report which will be serve by a display (e.g., BI screen or the like). The method can be used in assisting in generation of report for the graph database. In the proposed method, only report query is need to be configured and the method and the report management system does not require an additional development or modification. The method and the report management system can be scalable for large number of report as well.

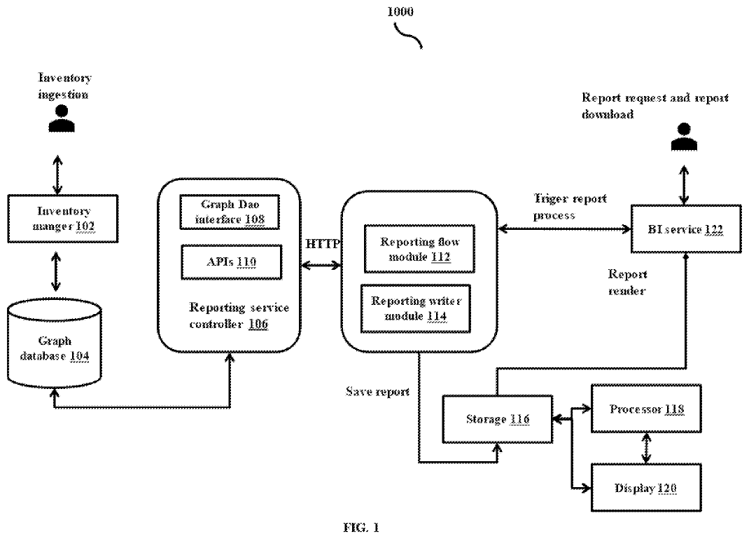

Referring now to the drawings and more particularly to FIGS. 1 through 4, where similar reference characters denote corresponding features consistently throughout the figures, there are shown preferred embodiments.

FIG. 1 is an example overview of a report management system (100) for generating a BI report, according to the embodiments as disclosed herein. The BI report presents data mining and/or predictive insights about multiple domain information and multiple technology information. The report management system (1000) can be, for example, but not limited to a computer system, a host server, a personal computer, a smart phone, a Personal Digital Assistant (PDA), a tablet computer, a laptop computer, an Internet of Things (IoT), embedded systems, edge devices, a vehicle to everything (V2X) device or the like.

The report management system (1000) includes an inventory manger (102), a graph database (104) (e.g., data lake or the like), a reporting service controller (106), a reporting flow module (112), a reporting writer module (114), a storage (116), a processor (118), and a display (120). The inventory manger (102) is coupled with the graph database (104), where the graph database (104) is coupled with the reporting service controller (106). The reporting service controller (106) includes a graph Dao interface (108) and a plurality of application programming interfaces (APIs) (110) (e.g., certified API or the like). The reporting service controller (106) is connected with the reporting flow module (112) and the reporting writer module (114). The reporting flow module (112) and the reporting writer module (114) are connected with the storage (116). The storage (116) is coupled with the processor (118) and the display (120).

The inventory manger (102) includes multiple domain information and multiple technology information. In an example, the inventory manger (102) includes a fifth generation (5G) base node related information and a sixth generation (6G) node related information. In an example, the inventory manger (102) includes a telecom vendor information, radio access technology (RAN) domain information and telecom service information. The multiple domain information and multiple technology information are stored in the graph database (104). By using the inventory manger (102), an inventory ingestion is a process of obtaining and importing data for immediate use or storage in the graph database (104).

The reporting flow module (112) and the reporting writer module (114) are interacted with the graph database (104) through the graph Dao interface (108) in the reporting service controller (106). The reporting flow module (112) and the reporting writer module (114) are interacted with the reporting service controller (106) using a HTTP link. The reporting flow module (112) and the reporting writer module (114) are interacted with the BI service (122) using a trigger report process. The BI service (122) receives a report request query and report download query. The report writer module (114) has a processing ability to take a basic standard list information in spark processing and convert into an XLS file.

The graph dao interface (108) is an data access layer in the inventory service to supper a basic CRUD operation from the graph database (104). A business logic use the data access layer as the interface to database it manage the reading, writing and updating of any inventory.

The reporting service controller (106) creates a BI report request to download the BI report using the BI template from the plurality of BI templates. The BI template includes meta-data for a report but doesn't contain the data itself. The BI template can be a TM Forum certified API template. The BI report request includes a list of data filters and a specific report format required by a user. In an embodiment, the reporting service controller (106) detects the template from the plurality of templates selected by the user and displays the selected template on the report management system (1000). Further, the reporting service controller (106) receives the list of filters and the specific requirements of the BI report in the selected template. Further, the reporting service controller (106) creates the BI report request to download the BI report based on the selected template, the list of filters and the specific requirements of the BI report.

Further, the reporting service controller (106) creates the connection with the graph database (104) using a certified API. The graph database includes graphs containing nodes, edges, and properties, all of which are used to represent and store the BI data.

Further, the reporting service controller (106) retrieves the BI data from the graph database (104) using the certified API based on the list of filters indicated in the BI report request. In an embodiment, the reporting service controller (106) creates a query to retrieve the BI data based on the list of filters indicated in the BI report request. Further, the reporting service controller (106) sends the query to the graph database (104) using the graph deo interface through the certified API. Further, the reporting service controller (106) receives the query response comprising the BI data from the graph database (104) using the graph deo interface through the certified API based on a CRUD (Create, Read, Update, Delete) operation.

Further, the reporting service controller (106) generates the BI report including the retrieved BI data from the graph database (104) based on the specific report format required by the user. In an embodiment, the reporting service controller (106) determines the list of fields to be included in the BI report based on the specific report format required by the user. Further, the reporting service controller (106) generates the BI report including the list of fields with corresponding BI data retrieved from the graph database. Further, the reporting service controller (106) stores the BI report in the storage (116) and displays the BI report on the display (120) to the user.

The proposed report management system (1000) can be used to assists in providing reporting solution for the graph database (104) with help of the processor (118) (e.g., generic report processor) in a BI tool. The proposed method can be used to integrate the generic process with the BI tool to fetch the data from a graph data source and creates the report which will be serve by the display (120) (e.g., BI screen or the like).

Further, the processor (118) is configured to execute instructions stored in the storage (116) and to perform various processes. The storage (116) also stores instructions to be executed by the processor (118). The storage (116) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the storage (116) may, in some examples, be considered a non-transitory storage medium. The term “non-transitory” may indicate that the storage medium is not embodied in a carrier wave or a propagated signal. However, the term “non-transitory” should not be interpreted that the storage (116) is non-movable. In certain examples, a non-transitory storage medium may store data that can, over time, change (e.g., in Random Access Memory (RAM) or cache).

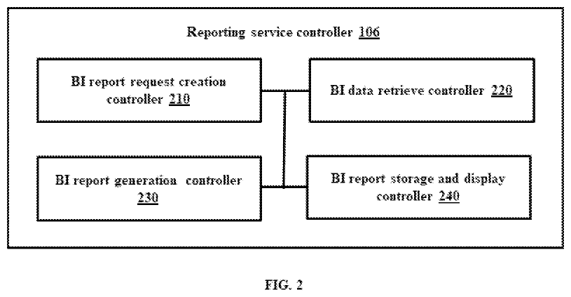

FIG. 2 shows various hardware components of the reporting service controller (106) of the report management system (1000), according to the embodiments as disclosed herein. The reporting service controller (106) includes a BI report request creation controller (210), a BI data retrieve controller (220), a BI report generation controller (230) and a BI report storage and display controller (240). The BI report request creation controller (210) is coupled with the BI data retrieve controller (220), the BI report generation controller (230) and the BI report storage and display controller (240).

The BI report request creation controller (210) creates the BI report request to download the BI report using the BI template from the plurality of BI templates. In an embodiment, the BI report request creation controller (210) detects the template from the plurality of templates selected by the user and displays the selected template on the display (120). Further, the BI report request creation controller (210) receives the list of filters and the specific requirements of the BI report in the selected template. Further, the BI report request creation controller (210) creates the BI report request to download the BI report based on the selected template, the list of filters and the specific requirements of the BI report.

Further, the BI report request creation controller (210) creates the connection with the graph database (104) using the certified API. The graph database (104) includes graphs containing the nodes, the edges, and the properties, all of which are used to represent and store the BI data.

The BI report request creation controller (210) is implemented by analog and/or digital circuits such as logic gates, integrated circuits, the processor (118), microprocessors, microcontrollers, memory circuits, passive electronic components, active electronic components, optical components, hardwired circuits and the like, and may optionally be driven by firmware.

Using the certified API, the BI data retrieve controller (220) retrieves the BI data from the graph database (104) based on the list of filters indicated in the BI report request. In an embodiment, the BI data retrieve controller (220) creates the query to retrieve the BI data based on the list of filters indicated in the BI report request. Further, the BI data retrieve controller (220) sends the query to the graph database (104) using the graph deo interface through the certified API. Further, the BI data retrieve controller (220) receives the query response comprising the BI data from the graph database (104) using the graph deo interface through the certified API based on the CRUD operation.

The BI data retrieve controller (220) is implemented by analog and/or digital circuits such as logic gates, integrated circuits, the processor (118), microprocessors, microcontrollers, memory circuits, passive electronic components, active electronic components, optical components, hardwired circuits and the like, and may optionally be driven by firmware.

The BI report generation controller (230) generates the BI report including the retrieved BI data from the graph database (104) based on the specific report format required by the user. In an embodiment, the BI report generation controller (230) determines the list of fields to be included in the BI report based on the specific report format required by the user. Further, the BI report generation controller (230) generates the BI report including the list of fields with corresponding BI data retrieved from the graph database (104).

The BI report generation controller (230) is implemented by analog and/or digital circuits such as logic gates, integrated circuits, the processor (118), microprocessors, microcontrollers, memory circuits, passive electronic components, active electronic components, optical components, hardwired circuits and the like, and may optionally be driven by firmware.

The BI report storage and display controller (240) stores the BI report in the storage and displays the BI report on the display (120) to the user. The BI report storage and display controller (240) is implemented by analog and/or digital circuits such as logic gates, integrated circuits, the processor (118), microprocessors, microcontrollers, memory circuits, passive electronic components, active electronic components, optical components, hardwired circuits and the like, and may optionally be driven by firmware.

The reporting service controller (106) can be used to assists in providing reporting solution for the graph database (104) with help of the processor (118) (e.g., generic report processor) in a BI tool. The proposed method can be used to integrate the generic process with the BI tool to fetch the data from the graph data source and creates the report which will be serve by the display (e.g., BI screen or the like) (120).

Although the FIG. 2 shows various hardware components of the reporting service controller (106) but it is to be understood that other embodiments are not limited thereon. In other embodiments, the reporting service controller (106) may include less or more number of components. Further, the labels or names of the components are used only for illustrative purpose and does not limit the scope of the invention. One or more components can be combined together to perform same or substantially similar function in the reporting service controller (106).

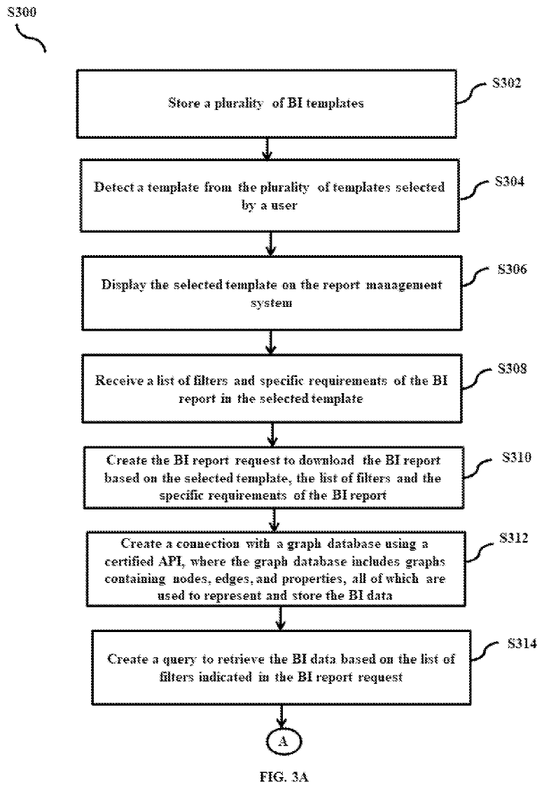

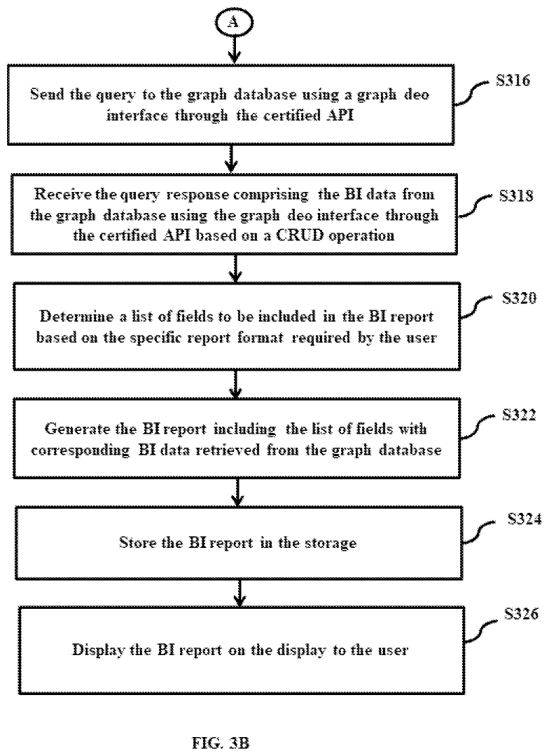

FIG. 3A and FIG. 3B are flow charts (S300) illustrating a method for generating the BI report, according to the embodiments as disclosed herein. The operations (S302-S326) are handled by the reporting service controller (106).

At S302, the method includes storing the plurality of BI templates. At S304, the method includes detecting the template from the plurality of templates selected by the user. At S306, the method includes displaying the selected template on the report management system (1000). At S308, the method includes receiving the list of filters and the specific requirements of the BI report in the selected template. At S310, the method includes creating the BI report request to download the BI report based on the selected template, the list of filters and the specific requirements of the BI report. At S312, the method includes creating the connection with the graph database (104) using the certified API. The graph database (104) includes graphs containing the nodes, the edges, and the properties, all of which are used to represent and store the BI data. At S314, the method includes creating the query to retrieve the BI data based on the list of filters indicated in the BI report request.

At S316, the method includes sending the query to the graph database (104) using the graph deo interface through the certified API. At S318, the method includes receiving the query response comprising the BI data from the graph database (104) using the graph deo interface through the certified API based on the CRUD operation. At S320, the method includes determining the list of fields to be included in the BI report based on the specific report format required by the user. At S322, the method includes generating the BI report including the list of fields with corresponding BI data retrieved from the graph database (104). At S324, the method includes storing the BI report in the storage (116). At S326, the method includes displaying the BI report on the display (120) to the user.

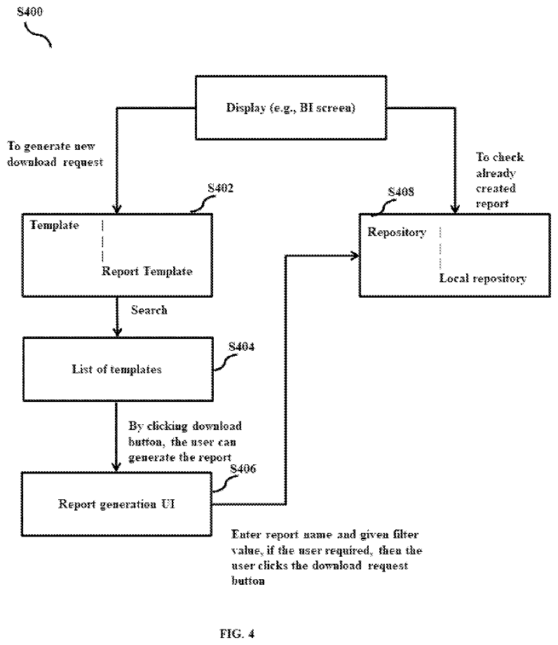

FIG. 4 is an example flow chart (400) illustrating a method for generating the BI report, according to the embodiments as disclosed herein. The operations (S402-S408) are handled by the reporting service controller (106).

The display (e.g., BI screen or the like) receives the request from the user to generate the BI report. At S402 and at S404, upon generation of the BI report, the report management system (1000) determines the BI template from the plurality of BI templates to create the BI report request to download the BI report. After determining the BI template, the method displays a report generation UI at S406. By clicking download button, the user can generate the report on the report generation UI. In an embodiment, the user enters the report name and given filter value, if the user required, then the user clicks the download request button to generate the BI report. The generated BI report is stored in a repository at S408. In order to check a report status, the user of the report management system (1000) can search your report name in a local repository module (not shown).

In an example, the user of the report management system (1000) creates the download request to generate the file for required data. In report management system, there is a facility to generate the file of data which retrieves from a database (e.g., my SQL DB or the like) but this flow can create a file of graph DB data. Based on the proposed methods, the method triggers the TMF certified API to obtain the data from the graph database (104). The TMF Certified API accepts many of the filters which user can set while creating a download request. In order to create the download request, the user of the report management system (1000) have to follow steps such as an open BI studio tool in the report management system, where the user will find a report template module and search inventory manager to filter the inventory specific report from all report available in the BI Tool. The user of the report management system (1000) finds multiple report with inventory management category and report name according to data. In order to generate the download request, the user of the report management system (1000) have to hover or gesture on a report name and click on a download button. Further, the user of report management system (1000) enters a report name and selects your filters if any required then, the user of the report management system (1000) clicks the create download request button. In order to check a report status, the user of the report management system (1000) can search your report name in the local repository module.

The method can be used to assists in providing reporting solution for a graph based system with help of the processor (118) (e.g., generic report processor) in a BI tool. The proposed method can be used to integrate the generic process with the BI tool to fetch the data from the graph data source and creates the report which will be serve by the display (e.g., BI screen or the like) (120). The method can be used in assist in generation of report for the graph database (104). In the proposed methods, only report query is need to be configured and the method does not require an additional development. The method and system (1000) can be scalable for large number of report as well.

The various actions, acts, blocks, steps, or the like in the flow charts (S300 and S400) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

We claim:

1. A report management system for generating business intelligence (BI) report, wherein the report management system comprises:
a display;
a processor;
a storage coupled to the processor, wherein the storage storing a plurality of BI templates;
a reporting service controller, coupled to the processor and the display, configured to:
create a BI report request to download the BI report using a BI template from the plurality of BI templates, wherein the BI report request comprises a list of data filters and a specific report format required by a user;
create a connection with a graph database using a certified API, wherein the graph database comprises graphs containing nodes, edges, and properties, all of which are used to represent and store the BI data;
retrieve the BI data from the graph database using the certified API based on the list of filters indicated in the BI report request;
generate the BI report comprising the retrieved BI data from the graph database based on the specific report format required by the user;
store the BI report in the storage; and
display the BI report on the display to the user.

2. The report management system as claimed in claim 1, wherein create the BI report request to download the BI report comprises:
detect a template from the plurality of templates selected by a user;
display the selected template on the report management system; and
receive the list of filters and the specific requirements of the BI report in the selected template;
create the BI report request to download the BI report based on the selected template, the list of filters and the specific requirements of the BI report.

3. The report management system as claimed in claim 1, wherein certified template is a TM Forum certified API.

4. The report management system as claimed in claim 1, wherein retrieve the BI data from the graph database using the certified API based on the list of filters indicated in the BI report request comprises:
create a query to retrieve the based on the list of filters indicated in the BI report request;
send the query to the graph database using a graph deo interface through the certified API; and
receive the query response comprising the BI data from the graph database using the graph deo interface through the certified API based on a CRUD (Create, Read, Update, Delete) operation.

5. The report management system as claimed in claim 1, wherein generate the BI report based on the specific report format required by the user comprises:
determine a list of fields to be included in the BI report based on the specific report format required by the user; and
generate the BI report comprising the list of fields with corresponding BI data retrieved from the graph database.

6. A method for generating business intelligence (BI) report, wherein the method comprises:
storing, by the report management system, a plurality of BI templates;
creating, by the report management system, a BI report request to download the BI report using a BI template from the plurality of BI templates, wherein the BI report request comprises a list of data filters and a specific report format required by a user;
creating, by the report management system, a connection with a graph database using a certified API, wherein the graph database comprises graphs containing nodes, edges, and properties, all of which are used to represent and store the BI data;
retrieving, by the report management system, the BI data from the graph database using the certified API based on the list of filters indicated in the BI report request;
generating, by the report management system, the BI report comprising the retrieved BI data from the graph database based on the specific report format required by the user;
storing, by the report management system, the BI report; and
displaying, by the report management system, the BI report on the display to the user.

7. The method as claimed in claim 6, wherein creating the BI report request to download the BI report comprises:
detecting, by the report management system, a template from the plurality of templates selected by a user;
displaying, by the report management system, the selected template on the report management system;
receiving, by the report management system, the list of filters and the specific requirements of the BI report in the selected template; and
creating, by the report management system, the BI report request to download the BI report based on the selected template, the list of filters and the specific requirements of the BI report.

8. The method as claimed in claim 6, wherein certified template is a TM Forum certified API.

9. The method as claimed in claim 6, wherein retrieving the BI data from the graph database using the certified API based on the list of filters indicated in the BI report request comprises:
creating, by the report management system, a query to retrieve the based on the list of filters indicated in the BI report request;
sending, by the report management system, the query to the graph database using a graph deo interface through the certified API; and
receiving, by the report management system, the query response comprising the BI data from the graph database using the graph deo interface through the certified API based on a CRUD (Create, Read, Update, Delete) operation.

10. The method as claimed in claim 6, wherein generating the BI report based on the specific report format required by the user comprises:
determining, by the report management system, a list of fields to be included in the BI report based on the specific report format required by the user; and
generating, by the report management system, the BI report comprising the list of fields with corresponding BI data retrieved from the graph database.
